(19) United States
(12) Patent Application Publication
(10) Pub. No.: US 2015/0049800 A1
(43) Pub. Date: Feb. 19, 2015

(54) ESTIMATION OF ENTROPY ENCODING BITS IN VIDEO COMPRESSION

(71) Applicant: NVIDIA Corporation, Santa Clara, CA (US)

(72) Inventors: Jianjun CHEN, Shanghai (CN); Yemin MA, Shanghai (CN)

(73) Assignee: NVIDIA CORPORATION, Santa Clara, CA (US)

(21) Appl. No.: 13/969,383

(22) Filed: Aug. 16, 2013

(51) Int. Cl. H04N 19/103; H04N 19/91; H04N 19/184; H04N 19/14; H04N 19/154

(52) U.S. Cl. CPC H04N 19/00018; H04N 19/00157; H04N 19/002; H04N 19/00309; H04N 19/00951
USPC 375/240.02

(57) ABSTRACT

A technique for encoding digital video data comprises determining an estimated number of real bits associated with performing one or more entropy encoding operations on a coding unit of digital video data. Based on the estimated number of real bits, an estimated cost of compressing the coding unit using a compression technique is determined, and the compression technique is selected to compress the coding unit based at least in part on the estimated cost.

### FIELD OF THE INVENTION

Embodiments of the present invention relate generally to computing systems and, more specifically, to estimating entropy encoding bits in video compression.

### DESCRIPTION OF THE RELATED ART

In many areas of modern computing, high-speed transmission of video data is critical to achieving targeted performance, for example in video streaming, cloud-based gaming, and the like. To facilitate transmitting video data at lower bit rates and storing video data using less storage space, various video compression techniques have been developed. While such video compression techniques are effective at reducing the size of encoded video bit streams, these techniques are typically computationally intensive and need to be implemented with very low latency.

For example, a so-called reference CODEC (coder-decoder) may be used in video compression schemes to make coding mode decisions. The reference CODEC is computationally intensive because, to achieve optimal results, it calculates bit-rate and distortion for each available coding result, and selects the coding method having superior bit-rate and distortion to encode a particular set of image data. Thus, the reference CODEC consumes significant computational resources performing rate and distortion calculations for multiple coding methods for each portion of video, even though only one coding method is selected for use. Furthermore, the complexity of reference CODEC operations can act as a latency bottleneck, particularly in wireless and mobile devices in which computing and power resources are limited.

One drawback to latency occurring during video compression, is that playback applications, e.g., streaming video, suffer significant lag time when control inputs such as pause, play, fast-forward, and rewind are initiated by an end user. An even more noticeable drawback to such latency is in interactive, cloud-based game applications, where a user may experience substantial slowing of the frame rate and poor interactivity whenever the user provides an input control to the game application. Such poor interactivity greatly impacts the quality of user experience.

As the foregoing illustrates, what is needed in the art is a more effective approach to making coding mode decisions and selecting video compression techniques to implement during operation.

### SUMMARY OF THE INVENTION

One embodiment of the present invention sets forth a method for encoding digital video data. The method includes determining an estimated number of real bits associated with performing entropy encoding operations on a coding unit of digital video data, based on the estimated number of real bits, determining an estimated cost of compressing the coding unit using a first compression technique, and selecting the first compression technique to compress the coding unit based at least in part on the estimated cost.

One advantage of the embodiment is that latency incurred for encoding image data is reduced, so that a user is not exposed to encoding latency when interacting with a video playback or cloud-based gaming application program. Another advantage is that less logic is used in the encoding process, which saves energy consumed by a processor chip that encodes the image data and space on such a processor chip. Thus, the embodiment provides a mode decision process that balances coding efficiency, video quality, and computation performance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a diagram illustrating a server-client system configured to implement one or more aspects of the present invention.

FIG. 1B is a block diagram illustrating a computer system configured to implement one or more aspects of the present invention.

FIG. 2 sets forth a flowchart of method steps for encoding digital video data, according to one embodiment of the present invention.

FIG. 3 illustrates a bit estimation curve, according to an embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

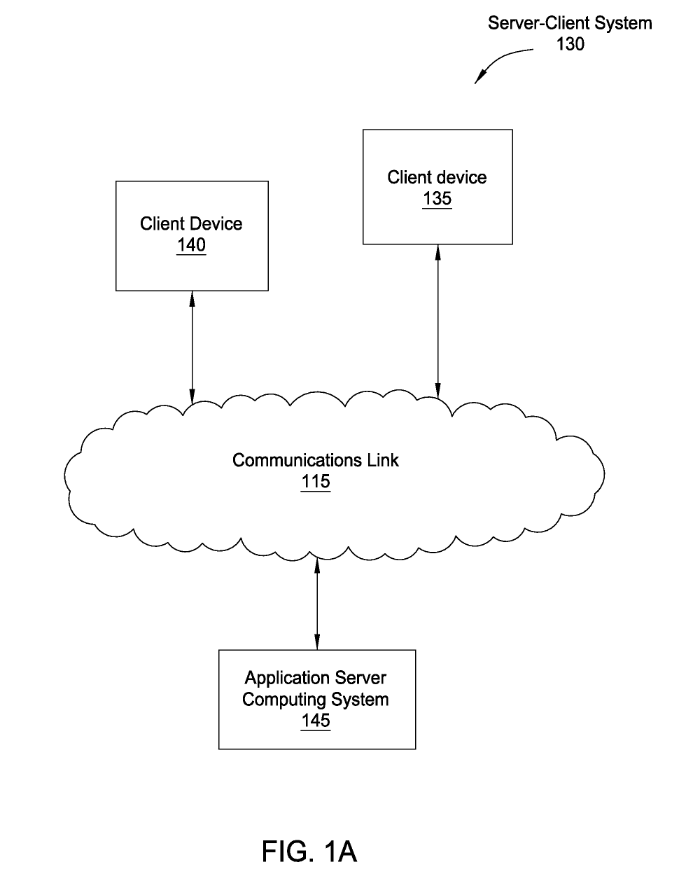

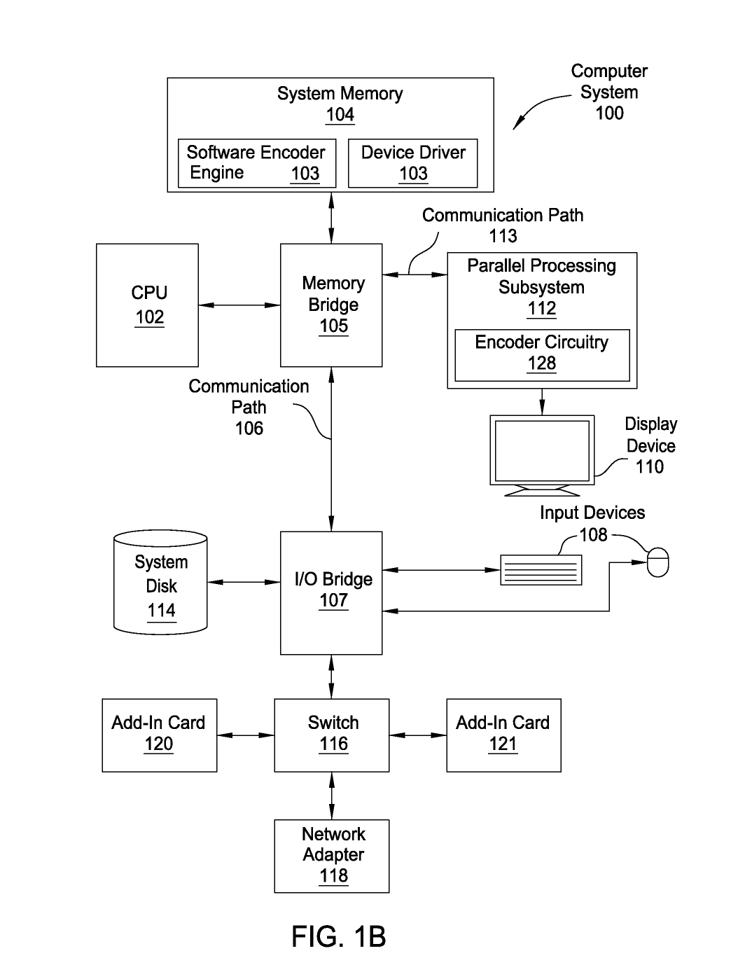

FIG. 1A is a diagram illustrating a server-client system 130 configured to implement one or more aspects of the present invention. As shown, the server-client system 130 includes an application server computing system 145, a client device 140, a client device 135, and a communications link 115.

The client devices 135 and 140 may each be configured to execute a client process that communicates with an application server process executed by the application server computing system 145 via communications link 115. The client process allows a user to remotely connect to the application server computing system 145 to cooperatively execute an interactive application program, such as video streaming or cloud gaming. The application server computing system 145 receives input control signals from the client devices 135 and 140 and renders image data in response to the input control signals. The input control signals are typically generated in response to user input provided via user input devices associated with client device 135 and 140. To reduce the bandwidth required to transmit the image data from the application server computing system 145 to the client devices 135 and 140, the image data is encoded into a compressed format at the application server computing system 145. The encoded image data is then transmitted to, decoded by, and displayed on the client device 135 and/or 140.

The communications link 115 includes a plurality of network communications systems, such as routers and switches, configured to facilitate data communication between the client process and the server process. Persons skilled in the art will recognize that many technically feasible techniques exist for building the communications link 115, including technologies practiced in deploying the well-known Internet communications network.

A plurality of client devices 135 and 140 can connect to the application server computing system 145 simultaneously via corresponding client processes. In one embodiment, the server-client system 130 does not use virtualization and allows several users to simultaneously execute different game application programs on a single application server computing system 145. The users of the client devices 135 and 140 connect and interact remotely with the game application programs stored on the application server computing system 145 and console. One or more interactive application programs may be executed on the application server computing system 145 by a combination of one or more CPU and/or GPU cores to produce rendered images that are encoded and transmitted over the communications link 115.

The application server computing system 145 and the client devices 135 and 140 may be any type of computing device including, but not limited to, a desktop personal computer (PC), a laptop, a tablet PC, a personal digital assistant (PDA) or a mobile device, such as a mobile phone. In one embodiment, the application server computing system 145 is a desktop computing system and the client devices 135 and 140 are portable devices located within the same building structure, such as a home or school. One embodiment of a computing device suitable for use as application server computing system 145 and/or the client devices 135 and 140 is described below in conjunction with FIG. 1B.

In operation, the server process, when initialized on the application server computing system 145, waits until a connection is initiated by the client process. Once client device 135 or 140 is connected to the application server computing system 145, client device 135 or 140 launches an interactive application and establishes a connection with the application server computing system 145. When initiating such a connection, the client process may transmit additional information, for example the resolution of a display device (not shown) coupled to the client device 135 and/or 140. When the application server computing system 145 receives the connection request, application server computing system 145 identifies the particular client and creates an execution environment to enable the interactive application program to execute on application server computing system 145. The interactive application program is also launched on the application server computing system 145.

Once the connection from the client process is established, the application server computing system 145 begins to collect rendered image data, encode the image data, and transmit the encoded image data to the respective client device 135 and/or 140. Client device 135 or 140 decodes the encoded image data that is received from the application server computing system 145 and displays the decoded image data at the output of the client device 135 or 140. The user of client device 135 or 140 generates input control signals to control the selected application program and the input control signals are transmitted to the application server computing system 145, which processes the input control signals and then proceeds to generate additional images in response to the input control signals for transmission to client device 135 or 140. This process continues until the client process terminates the connection between the server process and the client process.

Typically, application server computing system 145 is configured to maintain a frame rate of at least 60 frames per second for encoding and transmitting the image data. Because video compression schemes for performing this encoding are computationally intensive, significant latency can be incurred as a result of the encoding process, particularly when the image data being encoded is generated in response to input control signals received from client device 135 or 140. For playback application programs, such as streaming video applications, such latency is less intrusive on a user experience. This is because input control signals for playback application programs are typically limited to user inputs that simply position a playback point within the content or control a sampling frequency, e.g., rewind, fast-forward, play, pause, and the like, and users of playback application programs are generally accustomed to tolerating delay when playing, reversing, or fast-forwarding the content. In contrast, users of game applications are accustomed to low latency, so that the game application has a quick response time and is interactive. Consequently, the time needed for application server computing system 145 to receive input control signals, generate image data, and encode the image data can significantly affect the user experience.

According to embodiments of the present invention, latency incurred from encoding image data can be significantly improved by reducing the computational resources used for coding mode decisions in the encoding process. Specifically, prior to performing entropy encoding on a coding unit of digital video data, an estimate is made for the number of real bits associated with the coding unit after entropy encoding has been performed on the coding unit. In this way, a coding mode decision, i.e., selection of the compression mode that has the least rate distortion (RD), can be made without performing entropy encoding operations on the coding unit. Consequently, less logic is used for the coding mode decision and latency is significantly reduced.

FIG. 1B is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more of the other elements of FIG. 1B to form a single system. For example, parallel processing subsystem 112 may be integrated with CPU 102 and other connection circuitry on a single chip to form a system on chip (SoC).

According to embodiments of the present invention, parallel processing subsystem 112 may include dedicated encoder circuitry 128 for encoding and/or decoding image data, for example in conjunction with streaming video applications or interactive applications such as cloud-based game applications. In the embodiment shown in FIG. 1B, encoder circuitry 128 resides within the parallel processing subsystem 112. In other embodiments, encoder circuitry 128 may reside in a device or sub-system that is separate from parallel processing subsystem 112, such as memory bridge 105, I/O bridge 107, or add-in cards 120 or 121. In some embodiments, in lieu of or in addition to encoder circuitry 128, a software encoder engine 125 may be embodied as a set of program instructions loaded in system memory 104 to perform some or all of the desired encoding and/or decoding of image data in computer system 100.

In embodiments in which computer system 100 is configured as a server device, such as application server computing system 145 in FIG. 1A, encoder circuitry 128 is configured to produce encoded image data. Alternatively or in addition to encoder circuitry 128, program instructions in system memory associated with software encoder engine 125 may be executed by the CPU 102 to produce such encoded image data. Typically, the GPU stores rendered image data, such as RGB (red-green-blue) data, in either a buffer in graphics memory or system memory 104, reads and converts the stored RGB to YUV data, and stores the YUV data in a different buffer in graphics memory or system memory 104. The GPU converts the image data from RGB format to a YUV format to reduce the number of bits that represent each pixel. For an n×m pixel frame, a 32 bit per pixel RGB format requires n×m×4 bytes compared with a 4:2:0 YUV format that requires (n×m×3)/2 bytes. Encoder circuitry 128 and/or software encoder engine 125 then encodes the YUV data to produce the encoded image data.

In embodiments in which computer system 100 is configured as a client device, such as client device 135 and/or 140, encoder circuitry 128 is configured to produce decoded image data. In some embodiments, in lieu of or in addition to encoder circuitry 128, program instructions in system memory 104 that are associated with software encoder engine 125 may be executed by the CPU 102 to produce such decoded image data.

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 is connected to CPU 102 directly rather than through memory bridge 105, and other devices communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1B may not be present. For example, switch 116 may be eliminated, and network adapter 118 and add-in cards 120, 121 connect directly to I/O bridge 107.

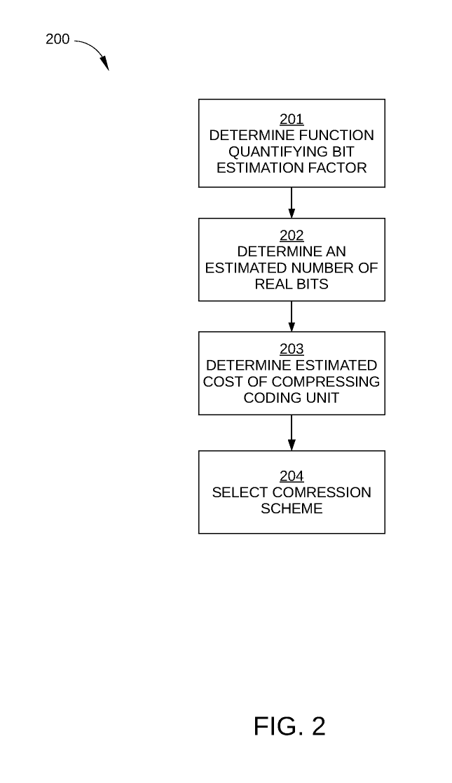

FIG. 2 sets forth a flowchart of method steps for encoding digital video data, according to one embodiment of the present invention. Although the method steps are described with respect to server-client system 130 of FIG. 1A and computer system 100 of FIG. 1B, persons skilled in the art will understand that any system configured to perform the method steps, in any order, falls within the scope of the present invention.

As shown, a method 200 begins at step 201, where a function is determined that quantifies how a bit estimation factor K varies as a function of quantization parameter (QP). The QP is associated with a particular coding unit of digital image data, such as a frame of a digital video or a macroblock that is associated with a portion of a frame of a digital video. Bit estimation factor K can then be used in a subsequent step of method 200 to estimate how many real bits a value associated with the data size of the coding unit will have after the coding unit undergoes entropy encoding, where such an estimate is performed prior to the coding unit undergoing entropy encoding.

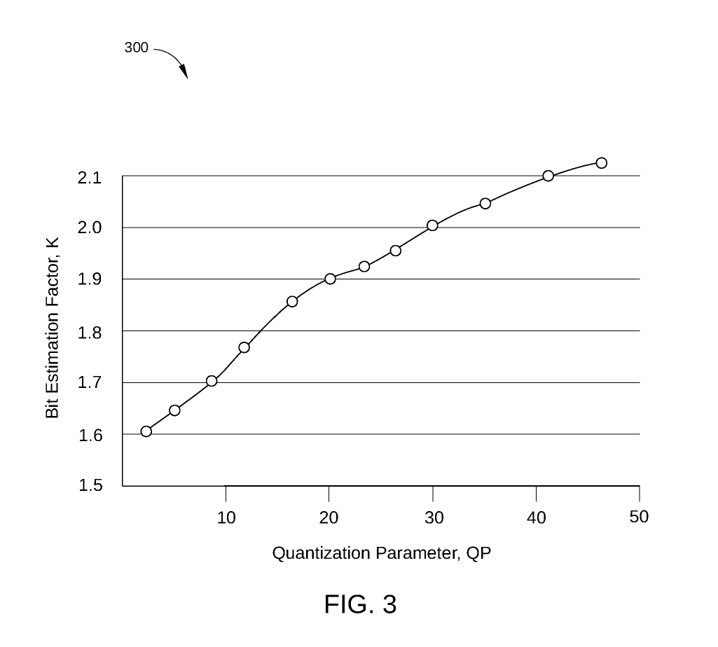

In some embodiments, the function quantifying how bit estimation factor K varies as a function of QP is determined by building a bit estimation curve empirically. In such embodiments, a bit estimation curve is constructed in the following manner. First, for a particular coding unit (referred to hereinafter as a “test coding unit”) and at a particular value of QP, the number of real bits in the value associated with the data size of the test coding unit is counted prior to undergoing entropy encoding. For example, in an embodiment in which the test coding unit prior to entropy encoding has a data size of one byte (eight bits, written as 100 in binary), the number of real bits is three. Second, the test coding unit undergoes entropy encoding and the number of real bits of the value associated with the data size of the test coding unit is again counted. As is well-known, entropy encoding is a lossless data compression scheme in which a unique code is assigned to each unique symbol that occurs in the input, where the most common symbols use the shortest codes. Third, the ratio of the real bits counted before the test coding unit undergoes entropy encoding to the real bits counted after the test coding unit undergoes entropy encoding is calculated and used to populate one point of the bit estimation curve. This process is repeated for the same test coding unit at different values of QP to generate a complete bit estimation curve. One embodiment of a such a bit estimation curve is illustrated in FIG. 3.

FIG. 3 illustrates a bit estimation curve 300 according to an embodiment of the present invention. As shown, bit estimation curve 300 is a one-to-one function, so that for each value of QP, there is a unique value for bit estimation factor K. In some embodiments, each data point is an average value that is determined by performing step 201 of method 200 multiple different test coding units.

In step 202 of FIG. 2, an estimated number of real bits is determined that is associated with performing entropy encoding operations on a coding unit of digital video data. The coding unit may include a frame of a YUV or RGB sequence of digital video or a macroblock that is associated with a portion of a frame of such a digital video. In some embodiments, the estimated number of real bits is an estimated number of real bits in a value associated with the data size (hereinafter referred to as the data size value) of the coding unit after the coding unit undergoes entropy encoding, and is based on a number of real bits counted in a data size value of the coding unit before the coding unit undergoes entropy encoding. Thus, to determine the estimated number of real bits in the data size value after performing entropy encoding is performed on the coding unit, the number of real bits is determined in the data size value of the coding unit before entropy encoding is performed on the coding unit. In such embodiments, the number of real bits in the data size value of the coding unit before entropy encoding is performed is determined by counting the leading zeros in the this value.

For example, in an embodiment in which the data size value of the coding unit is stored in a 32-bit register, the number of real bits of the data size value of the coding unit is 32 minus the number of leading zeros in this value. So if the coding unit has a data size of one byte (i.e., eight bits, written as 100 in binary, which is three real bits), the number of real bits is 32−29=3. In other words, the number of real bits of the data size value of the coding unit is determined by counting the number of zero bits in the data size value from the most significant bit to the first non-zero bit, and subtracting the counted number of zeros from the number of bits used to store the data size value. In some embodiments, in order to eliminate the sign bit, an absolute value of the data size value of the coding unit is used in step 202 to determine the estimated number of real bits in the data size value after entropy encoding is performed on the coding unit.

In some embodiments, the estimated number of real bits determined in step 202 is performed using Equation 1:

Bits_{Esi}=K*(A−N_{Leading Zeros}) (1)

where Bits_{Est}=estimated number of real bits associated with performing entropy encoding operations on a coding unit; K=a bit estimation factor taken from the bit estimation curve constructed in step 201; A=the number bits used to store the data size of the coding unit, for example 16, 32, 64, etc.; and N_{LeadingZeros}=the number of leading zeros counted from the most significant bit to the first non-zero bit of the value associated with the data size of the coding unit before entropy encoding is performed.

In step 203, an estimated cost of compressing the coding unit is determined based on the estimated number of real bits determined in step 202. In some embodiments, an estimated cost of compressing the coding unit is determined for multiple data compression techniques in step 203. Typically, cost is quantified as measured distortion plus the estimated number of real bits determined in step 202 times lambda. The measured distortion can be determined by comparing an original coding unit to a reconstructed version of the coding unit after the coding unit has been compressed. The factor lambda is used to convert the bits to the same level of distortion.

In step 204, a compression scheme is selected for compressing the coding unit, based at least in part on the estimated cost of compressing the coding unit that is determined in step 203.

As persons skilled in the art will appreciate, the approach of method 200, as described herein, may be applied to any technically feasible video video codec in which entropy encoding is used, such as H.265 High Efficiency Video Coding (HEVC), H.264/MPEG-4 AVC (Advanced Video Coding), and the like. Furthermore, method 200 may be used in conjunction with any known video formats.

In sum, one embodiment of the present invention sets forth a system and method for encoding rendered image data in an efficient manner. The encoding process includes performing a mode decision based on an estimated number of real bits associated with performing entropy encoding operations on a coding unit of image data. This allows a mode decision to be made without first performing entropy encoding on the coding unit or directly counting the number of real bits associated with a data size number corresponding to the coding unit. Consequently, a mode decision can be performed with less logic and in fewer clock cycles.

One advantage of the embodiment is that latency incurred for encoding image data is reduced, so that a user is not exposed to encoding latency when interacting with a video playback or cloud-based gaming application program. Another advantage is that less logic is used in the encoding process, which saves energy consumed by a processor chip that encodes the image data and space on such a processor chip. Thus, the embodiment provides a mode decision process that balances coding efficiency, video quality, and computation performance.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

We claim:

1. A computer-implemented method for encoding digital video data, the method comprising:
determining an estimated number of real bits associated with performing one or more entropy encoding operations on a coding unit of digital video data;
based on the estimated number of real bits, determining an estimated cost of compressing the coding unit according to a first compression technique; and
selecting the first compression technique to compress the coding unit based at least in part on the estimated cost.

2. The method of claim 1, wherein determining the estimated number of real bits comprises determining a number of leading zeros associated with a data size number corresponding to the coding unit before performing the one or more entropy encoding operations.

3. The method of claim 2, wherein determining the number of leading zeros comprises counting a number of consecutive zero bits from the most significant bit of the data size number to the first non-zero bit of the data size number.

4. The method of claim 3, wherein the most significant bit of the data size number is not a sign bit.

5. The method of claim 2, wherein determining the estimated number of real bits further comprises multiplying the number of leading zeros associated with the data size number by a bit estimation factor.

6. The method of claim 5, wherein the bit estimation factor varies as a function of a quantization parameter associated with the coding unit.

7. The method of claim 6, wherein the function is an empirically determined function.

8. The method of claim 7, wherein the function is empirically determined, at a particular value of the quantization parameter, by:
prior to performing the one or more entropy encoding operations on a test coding unit, counting a first number of real bits associated with a data size number corresponding to the test coding unit;
after the one or more entropy encoding operations are performed on the test coding unit, counting a second number of real bits associated with the data size number corresponding to the test coding unit; and
calculating a value of the function at the particular value of the quantization parameter based on the first number of real bits and the second number of real bits.

9. The method of claim 1, wherein the coding unit comprises a frame of a digital video or a macroblock that is associated with a frame of a digital video.

10. The method of claim 1, wherein the estimated number of real bits is based on a value associated with the data size of the coding unit after the coding unit undergoes entropy encoding.

11. A processing unit, comprising:
a logic circuit configured to:
determine an estimated number of real bits associated with performing one or more entropy encoding operations on a coding unit of digital video data;
based on the estimated number of real bits, determine an estimated cost of compressing the coding unit according to a first compression technique; and
select the first compression technique to compress the coding unit based at least in part on the estimated cost.

12. The processing unit of claim 11, wherein the logic circuit is configured to determine the estimated number of real bits by determining a number of leading zeros associated with a data size number corresponding to the coding unit before performing the one or more entropy encoding operations on the coding unit.

13. The processing unit of claim 12, wherein the logic circuit is configured to determine the number of leading zeros by counting a number of consecutive zero bits from the most significant bit of the data size number to the first non-zero bit of the data size number.

14. The processing unit of claim 13, wherein the most significant bit of the data size number is not a sign bit.

15. The processing unit of claim 12, wherein the logic circuit is configured to determine the estimated number of real bits by multiplying the number of leading zeros associated with the data size number by a bit estimation factor.

16. The processing unit of claim 15, wherein the bit estimation factor varies as a function of a quantization parameter associated with the coding unit.

17. The processing unit of claim 16, wherein the function comprises an empirically determined function.

18. The processing unit of claim 1, wherein the coding unit comprises a frame of a digital video or a macroblock that is associated with a frame of a digital video.

19. The processing unit of claim 1, wherein the estimated number of real bits is based on a value associated with the data size of the coding unit after the coding unit undergoes entropy encoding.

20. A computing device comprising:
a memory; and
a processor coupled to the memory and including a logic circuit configured to:
determine an estimated number of real bits associated with performing one or more entropy encoding operations on a coding unit of digital video data;
based on the estimated number of real bits, determine an estimated cost of compressing the coding unit according to a first compression technique; and
select the first compression technique to compress the coding unit based at least in part on the estimated cost.
